(19) United States
(12) Patent Application Publication
(10) Pub. No.: US 2023/0301853 A1
(43) Pub. Date: Sep. 28, 2023

(54) MEDICAL AUTOMATIC TURNOVER BED

(71) Applicant: GOLDEN SENSE INDUSTRIAL CO., LTD., Taoyuan City (TW)

(72) Inventor: Rocky Chuang, Taoyuan City (TW)

(73) Assignee: GOLDEN SENSE INDUSTRIAL CO., LTD., Taoyuan City (TW)

(21) Appl. No.: 17/704,091

(22) Filed: Mar. 25, 2022

(51) Int. Cl. A61G 7/018; A61G 7/00; A61G 7/05

(52) U.S. Cl. CPC A61G 7/018; A61G 7/001; A61G 7/0504

(57) ABSTRACT

A medical automatic turnover bed includes: a fixed bed frame; a turnover bed frame suspended above the fixed bed frame; an electric driving device installed at the fixed bed frame for flipping the turnover bed frame sideways; a bed board installed with a space apart from the turnover bed frame and provided for a patient to lie on; and fasteners arranged on left and right sides of the bed board or the turnover bed frame and manually or automatically flappable to change the position to a proximate position or a far position relative to the sides of the patient's body. In this way, the medical automatic turnover bed can secure the patient's body safely and can be turned sideways automatically to change the pressed position of the patient's body, so as to achieve the effects of turning over the patient conveniently, preventing bedsores, and reducing the work of caregivers.

### BACKGROUND OF THE INVENTION

### Field of the Invention

The present invention relates to nursing care beds, in particular to a medical automatic turnover bed provided for the use by long-term bedridden patients who cannot roll over in bed on their own.

### Description of Related Art

Bedsores (also known as pressure sores) are damages to the skin that usually occur over the body of long-term bedridden patients as a result of long-term pressure, bedsores. The most common sites are the patients' hips, backs, heads, and heels. Caregivers must turn over the bedridden patients in bed frequently in order to avoid the occurrence of bedsores caused by compressing the same part of the body for a long time. For the caring of the patients who cannot turn over in bed by themselves, the major nursing care pressure and burden reside on that the patients must be turned over regularly to avoid the occurrence of bedsores and the complication such as bedsores, so that the patients' relatives and caregivers will be very busy.

Conventional hospital beds or general beds usually do not have the function of automatically turning over the body of a patient, but simply allow the patients to lie on the bed in a fixed posture, so that the patient completely relies on relatives and caregivers to turn over his/her body with manpower.

Although there are some special medical mattresses in the market which claim to be able to disperse the pressure of the patient's body lying down and reduce the risk of bedsores, the nursing method prescribed by the doctor is to turn over the patient's body regularly instead of using the mattresses to replace the nursing work, so that the use of such special-made mattresses is not a standard caring method.

Therefore, it is a main subject of this disclosure to design and develop a medical automatic turnover bed for long-term bedridden patients (who cannot turn over in bed by themselves) to turn over automatically, regularly, and safely, and hand over the turning work to the automated machine to complete the turning work automatically.

### SUMMARY OF THE INVENTION

In view of the aforementioned drawback of the conventional medical beds, the inventor of the present invention based on years of experience in the related industry to conduct research and experiment extensively and finally developed a medical automatic turnover bed to achieve the effects of turning over a patient's body conveniently, preventing bedsores, and reducing the work of caregivers.

Therefore, it is a primary objective of the present invention to provide a medical automatic turnover bed formed by a fixed bed frame, a turnover bed frame, an electric driving device, a bed board and a fastener, which can achieve the effects of facilitating patients to turn over their body in bed, preventing bedsores, and reducing the work of caregivers.

A secondary objective of the present invention is to provide a medical automatic turnover bed having a plurality of fasteners on both sides of the bed board or the turnover bed frame for safely fixing the patient's body for automatic turnover.

Another objective of the present invention is to provide a medical automatic turnover bed with a design of the bed board capable of supporting the patient's body and removing some boards of the bed board to form a hollow portion to facilitate applying medicine onto or cleaning the patient's body.

To achieve the aforementioned and other objectives, the present invention discloses a medical automatic turnover bed including: a fixed bed frame, placed horizontally on a floor; a turnover bed frame, installed and spaced from the top of the fixed bed frame, and having front and rear ends respectively and rotatably pivoted to front and rear ends of the fixed bed frame; an electric driving device, installed at a front end or a rear end of the fixed bed frame, and linked to drive the turnover bed frame to turn over sideway on the fixed bed frame; a bed board, installed and spaced from the top of the turnover bed frame, and provided for the patient to lie thereon; and a plurality of fasteners, arranged on both left and right sides of the bed board or the turnover bed frame, and having an end movably pivoted to the left and right sides of the bed board or the turnover bed frame, wherein the fastener can be turned manually or automatically relative to a proximate position and a far position at both sides of the patient's body to change positions, and the proximate position is defined as a position where the fastener can abut against both sides of the patient's body, and the far position is defined as a position where the fastener is far from both sides of the patient's body and can release the patient's body.

The medical automatic turnover bed of the present invention is provided for a patient to lie on the bed board, and the body fixing arms on both sides of the bed board can be turned upwardly to the proximate positions on both sides of the patient's body to abut against both sides of the patient's body, and then a safety belt is passed through the two corresponding body fixing arms to securely fix the patient's body and set the patient's arm at proper positions. In this way, the scheduled operation time of the electric driving device can be set to drive the turnover bed frame and the bed board to turn to sideway (either left or right) with a selected angle, such that the patient's body can change the pressed position regularly to achieve the effects of preventing the same part of the patient's body from being pressed for a long time, facilitating the patient to turn over on bed, preventing bedsores, and reducing the work of caregivers effectively, and other effects of the present invention will be described with the preferred embodiments.

### BRIEF DESCRIPTION OF THE DRAWINGS

FIG. 1 is a schematic view of a medical automatic turnover bed in accordance with a preferred embodiment of the present invention;

FIG. 2 is a bottom view of a two-piece bed board and separable boards in accordance with a preferred embodiment of the present invention;

FIG. 3 is a front view of a fastener moved to two proximate positions on both sides of a patient's body separately in accordance with the present invention;

FIG. 4 is a front view of a fastener moved to two far positions on both sides of a patient's body separately in accordance with the present invention;

FIG. 5 is a schematic view of a two-piece bed board and a supporting device supporting the bed board with an inclination in accordance with the present invention; and

FIG. 6 is a schematic view showing the action of turning a turnover bed frame and a bed board of a medical automatic turnover bed sideway in accordance with the present invention.

### DESCRIPTION OF THE PREFERRED EMBODIMENTS

The aforementioned and other objects, characteristics and advantages of the present invention will become apparent with the detailed description of the preferred embodiments and the illustration of related drawings as follows.

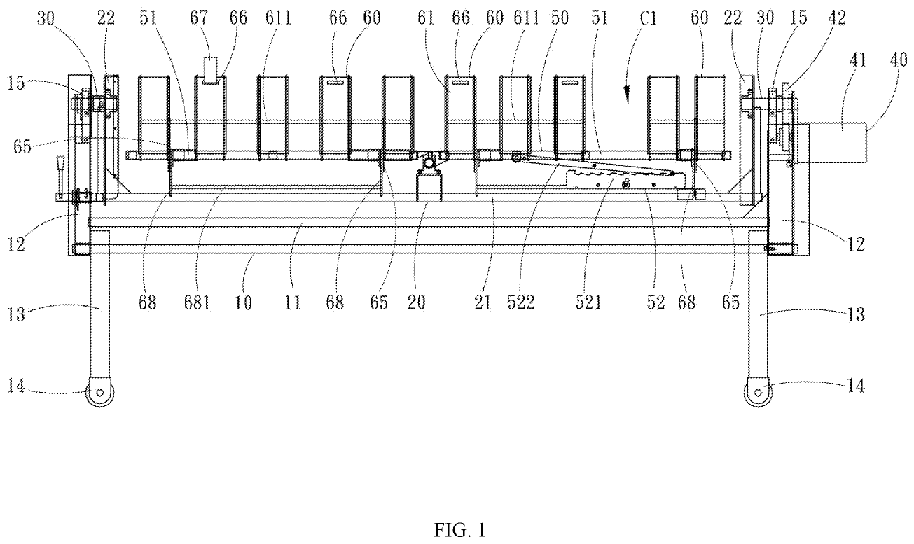

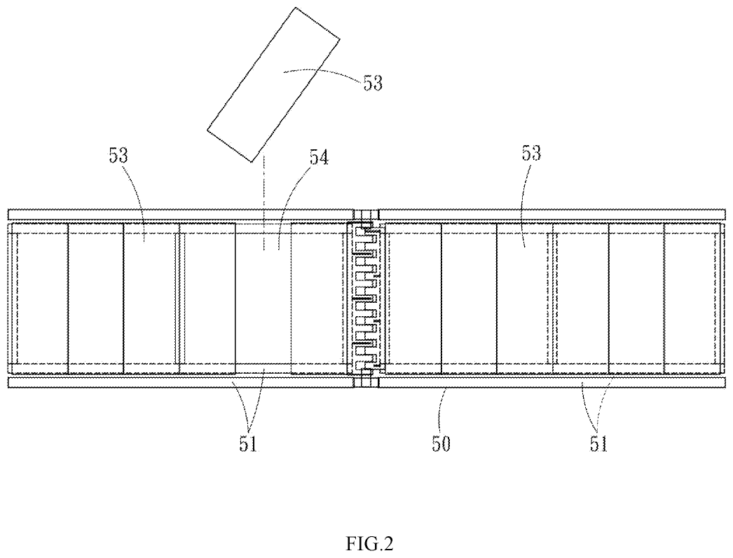

With reference to FIGS. 1 to 3 for a medical automatic turnover bed of the present invention, the medical automatic turnover bed is a special bed provided for the patients who cannot turn over in bed by themselves to automatically turn their body 100, and a preferred embodiment of this invention includes a fixed bed frame 10, a turnover bed frame 20, two shafts 30, an electric driving device 40, a bed board 50 and a plurality of fasteners 60.

The fixed bed frame 10 is placed horizontally on a floor and composed of a first horizontal frame 11 made of steel, and two first vertical frames 12 disposed on both front and rear ends of the first horizontal frame 11 respectively; the length and width of the first horizontal frame 11 are substantially the same as the size of a general patient's body; and the first vertical frame 12 is extended upwardly from the front and rear ends of the first horizontal frame 11. In addition, the bottom of the first horizontal frame 11 is combined with a plurality of bed feet 13, and a roller 14 is installed to the bottom of each bed foot 13, such that the fixed bed frame 10 can be used to move the patient.

The turnover bed frame 20 is arranged with a space from the top of the fixed bed frame 10, and its front and rear ends are rotatably pivoted to the front and rear ends of the fixed bed frame 10, such that the turnover bed frame 20 can be turned to left and right sideway. Specifically, the turnover bed frame 20 is formed by a second horizontal frame 21 made of steel and two vertical frames 22 disposed on both front and rear ends of the second horizontal frame 21 respectively; the second horizontal frame 21 is arranged with a space from the top of the first horizontal frame 11 of the fixed bed frame 10, so that the second horizontal frame 21 has sufficient space to turn to the left and right; the second vertical frame 22 is extended upwardly from the front and rear ends of the second horizontal frame 21 and disposed adjacent to the inner side of the first vertical frame 12.

The two shafts 30 are axially connected in a horizontal direction between the first vertical frame 12 and the second vertical frame 22, such that the turnover bed frame 20 can rotate to the left and right with the shaft 30 as a fulcrum. In a preferred embodiment, the shaft 30 has an end horizontally fixed to the second vertical frame 22 of the turnover bed frame 20 and the other installed to the first vertical frame 12 through a separable structure, such that the turnover bed frame 20 not only can be driven to turn to the right and left, but also can be separated from the fixed bed frame 10 through the separable structure, so that the patient together with the turnover bed frame 20 can be move to other places conveniently, without the need of carrying the fixed bed frame 10 for the moving. In a preferred embodiment, the separable structure has a groove 15 concavely formed on the first vertical frame 12 and provided for receiving the shaft 30 during the assembling of the turnover bed frame 20, and separating the turnover bed frame 20 by lifting the shaft 30 from the groove 15.

The electric driving device 40 is used as a power source and installed at the front or rear end of the fixed bed frame 10, and combined with the turnover bed frame 20 to drive the turnover bed frame 20 to turn to left and right above the fixed bed frame 10. In a specific embodiment, the electric driving device 40 has a motor 41 and a reduction transmission mechanism 42 which are mounted on the outer side of the first vertical frame 12 at an end of the fixed bed frame 10, and the motor 41 is controlled by a digital controller (not shown in the figure), such that it can be turned at a scheduled time to drive the reduction transmission mechanism 42, wherein the reduction transmission mechanism 42 can be a reduction gear set, a reduction gearbox or any other known equivalent reduction gear, and the motor 41 drives the turnover bed frame 20 to turn to a selected angle, and parameters such as the turnover time and angle can be set by the digital controller.

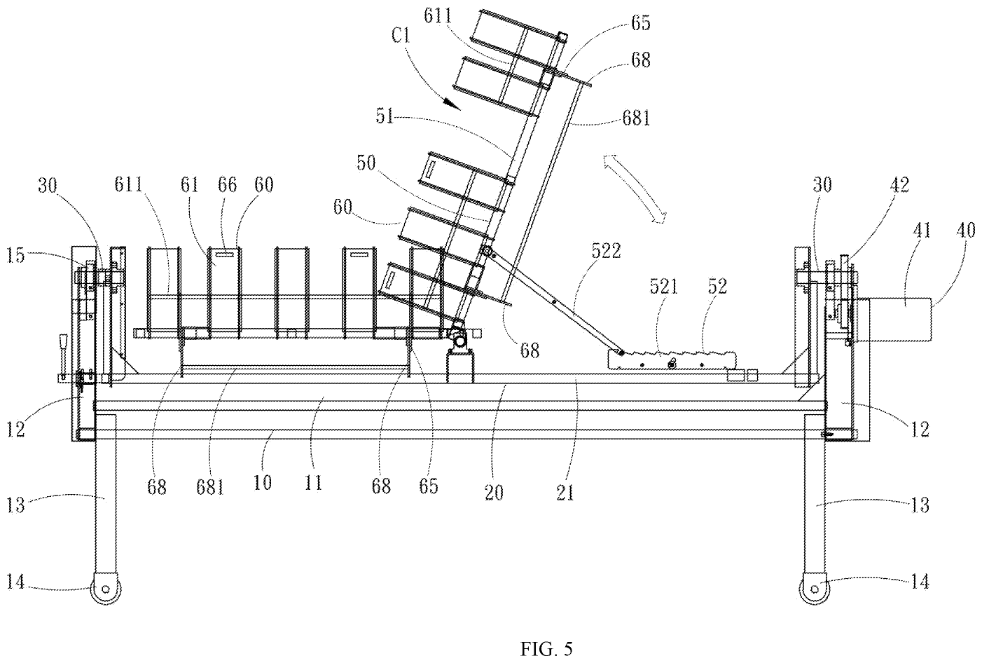

The bed board 50 is arranged with a space from the top of the second horizontal frame 21 of the turnover bed frame 20 and provided for a patient to lie on the bed board 50. Wherein, the bed board 50 can be a one-piece bed board or a two-piece bed board, and the one-piece bed board has a bed board frame 51 and a board 53 mounted onto the bed board frame 51; the two-piece bed board has two bed board frames 51 movably pivoted to each other, a supporting device 52, and a board 53 mounted onto each of the bed board frame 51. The bottom of the bed board frame 51 of one of the two bed board frames 51 is fixed onto the second horizontal frame 21, and the bottom of the other bed board frame 51 has the supporting device 52. The supporting device 52 is installed under one of the two bed board frames 51 and has a multi-stage positioning device 521 and a support rod 522, and the support rod 522 has an end pivotally connected to the bottom of the bed board frame 51 and the other end disposed at a switching position of the multi-stage positioning device 521 and provided for supporting a bed board frame 51 to tilt to a selected angle (as shown in FIG. 5), so as to facilitate to lift the patient's upper body into a reclining posture. Preferably, the bed board 50 (bed board frame 51) has a plurality of boards 53 mounted thereon and arranged side by side with one another and installed on the bed board frame 51, and some selected boards 53 can be disassembled and separated to form a hollow portion 54, so as to facilitate applying medicine onto or cleaning the patient's body.

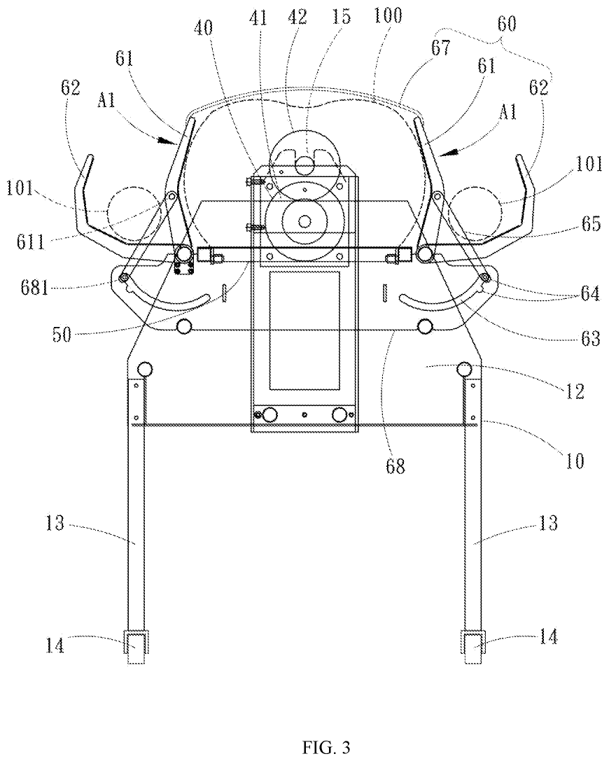

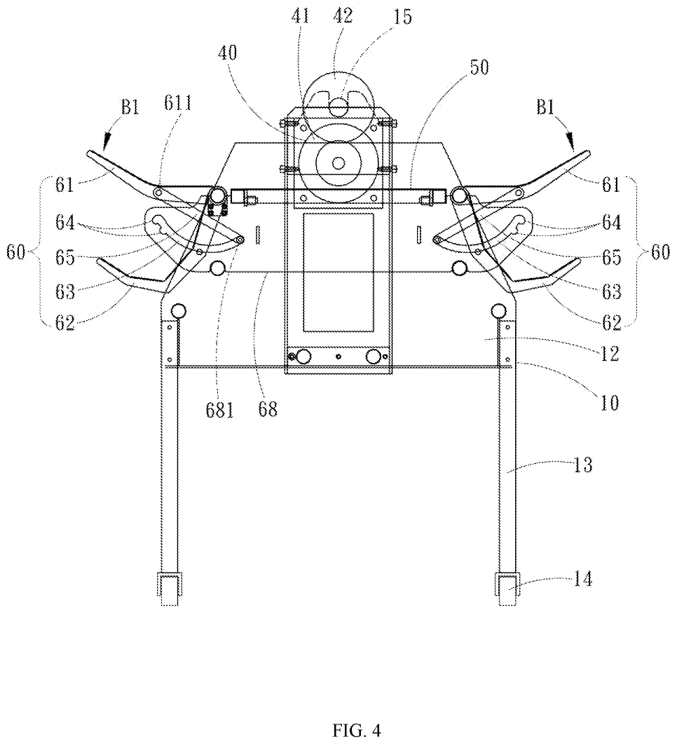

The plurality of fasteners 60 is arranged on left and right sides of the bed board 50 or the turnover bed frame 20 respectively and an end of the fastener 60 is movably pivoted to the left and right sides of the bed board 50 or the turnover bed frame 20, and a manual turnover assembly or an automatic turnover assembly is provided, such that the fastener 60 can switch positions between a proximate position A1 (as shown in FIG. 3) and a far position B1 (as shown in FIG. 4) relative to both sides of the patient's body 100, and the proximate position A1 is defined as a position where the fastener 60 abuts against both sides of the patient's body 100, and the far position B1 is defined as a position where the fastener 60 is far from both sides of the patient's body 100 and can release the patient's body.

In an embodiment, the fastener 60 includes a body fixing arm 61, and an arm supporting arm 62 disposed on an outer side of the body fixing arm 61, and the body fixing arm 61 and the arm supporting arm 62 are curved rods. The body fixing arm 61 is arranged on both sides of the bed board 50, such that the body fixing arm 61 has an end movably pivoted to the left and right sides of the bed board 50 or the turnover bed frame 20 and the other end capable of switching positions between the proximate position A1 and the far position B1. The arm supporting arm 62 is only installed on the body fixing arm 61 at the arm position, and the body fixing arm 61 on both sides of the patient's leg does not need to be installed with the arm supporting arm 62, such that the arm supporting arm 62 is combined with an end of the body fixing arm 61 to form a linking structure that can switch positions between the proximate position A1 and the far position B1, and the other is separated such that an included angle is defined between the body fixing arm 61 and the arm supporting arm 62). In this way, the body fixing arm 61 at the proximate position A1 abuts against both sides of the patient's body 100, so that the patient's body can be fixed to prevent the patient from falling off the bed when turning left and right, and the arm supporting arm 62 can provide a gap C1 as shown in FIG. 1 for extending the patient's arm 101 and placing the arm thereon (as shown in FIG. 3).

In the manual turnover assembly of the fastener 60 as shown in FIGS. 3 to 5, two or more boards 68 with the front and rear aligned precisely with each other are installed under the bed board 50 or the turnover bed frame 20, and both sides of each board 68 have a guide rail 63 which is an arc groove or in other forms, and the stroke of the guide rail 63 has one or two or more positioning portions 64; and a plurality of connecting rods 65, each having an end pivotally connected to the body fixing arm 61 and the other movable in the guide rail 63, and when the end of the connecting rod 65 is moved to the positioning portion 64, its movement will be limited by the positioning portion 64 (as shown in FIG. 3), such that the body fixing arm 61 is fixed to the proximate position A1. Wherein, a reinforcing rod 681 is provided for connecting the front and rear boards 68 to reinforce the structural strength of the two boards 68. The body fixing arms 61 can be connected in series by a link rod 611. Through the action of turning the body fixing arm 61 by a caregiver, each of the serially connected body fixing arm 61 can switch positions between the proximate position A1 and the far position B1. In order to fix the patient's body more securely, the end near the top of the body fixing arm 61 has a through hole 66 provided for passing a safety belt 67 into the through hole 66 which is configured to be corresponsive to the two body fixing arms 61 in order to secure the patient's body; or the end near the top of the arm supporting arm 62 has a through hole 66 to achieve the same effect of securely fixing the patient's body.

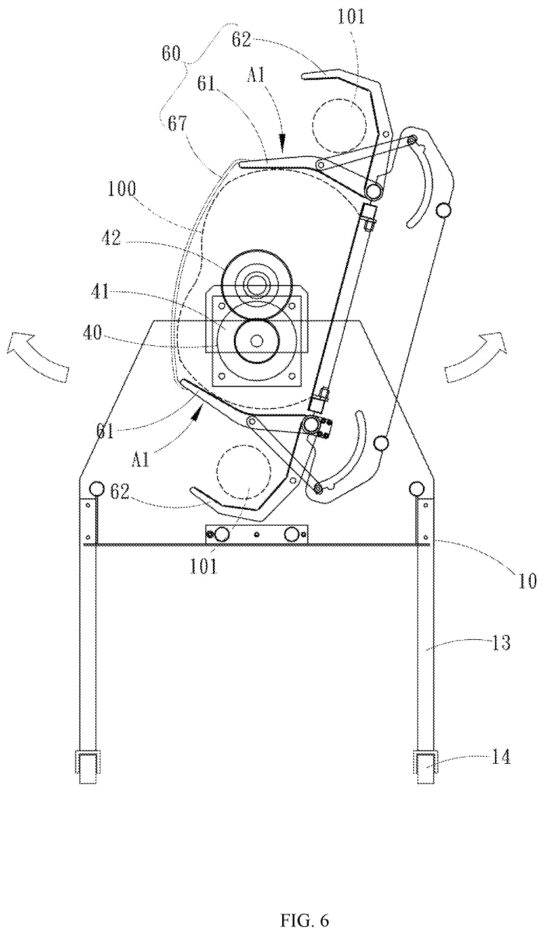

In an application of the present invention, the patient lies on the bed board 50, and a caregiver operates the fastener 60 to turn, such that the body fixing arms 61 on both sides of the bed board 50 is turned upwardly to the proximate position A1 on both sides of the patient's body (as shown in FIG. 3) to abut the patient's arm 101 on both sides of patient's body 100 and allow the patient to stretch from a gap C1 between the plurality of fasteners 60 (as shown in FIG. 1) and place the patient's arm on the arm supporting arm 62 (as shown in FIG. 3). The safety belt 67 is then passed through the through hole 66 formed on the two body fixing arms 61/arm supporting arms 62 to securely fix the patient's body, and then the caregiver can set a scheduled operation time (such as once for every hour) of the electric driving device 40 to drive the turnover bed frame 20 and the bed board 50 to turn left or right with an angle (as shown in FIG. 6), so as to achieve the effects of pressing the same part of the patient's body in bed for a long time, facilitating the patients to turn over, preventing bedsores and reducing the work of the caregivers.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A medical automatic turnover bed, provided for a patient to lie thereon, and for automatically turning over the patient's body at a schedule time, comprising:
a fixed bed frame, horizontally placed on a floor;
a turnover bed frame, installed and spaced from the top of the fixed bed frame, and having front and rear ends respectively and rotatably pivoted to front and rear ends of the fixed bed frame;
an electric driving device, installed at a front end or a rear end of the fixed bed frame, and linked to drive the turnover bed frame to turn over sideway on the fixed bed frame;
a bed board, installed and spaced from the top of the turnover bed frame, and provided for the patient to lie thereon; and
a plurality of fasteners, arranged on both left and right sides of the bed board or the turnover bed frame, and having an end movably pivoted to the left and right sides of the bed board or the turnover bed frame, wherein the fastener can be turned manually or automatically relative to a proximate position and a far position at both sides of the patient's body to change positions, and the proximate position is defined as a position where the fastener can abut against both sides of the patient's body, and the far position is defined as a position where the fastener is far from both sides of the patient's body and can release the patient's body.

2. The medical automatic turnover bed according to claim 1, wherein the fastener comprises a body fixing arm and an arm supporting arm disposed on an outer side of the body fixing arm; the body fixing arm has an end movably pivoted to left and right sides of the bed board or the turnover bed frame and the other end switchable between the proximate position and the far position independently; and the arm supporting arm has an end combined and linked with the body fixing arm and the other end is separated, so that an included angle is defined between the arm supporting arm and the body fixing arm.

3. The medical automatic turnover bed according to claim 2, wherein the bed board or the turnover bed frame comprises two guide rails disposed under the left and right sides thereof and having their fronts and ends aligned precisely with each other, and the guide rail has one or two or more positioning portions; and a plurality connecting rods arranged on front and rear sides respectively, and the connecting rod has an end pivotally coupled to the body fixing arm and the other end movable in the guide rail; and the plurality of body fixing arms arranged on front and rear sides can be coupled in series by a link rod, to link the plurality of body fixing arms altogether.

4. The medical automatic turnover bed according to claim 1, wherein the bed board comprises a one-piece bed board or a two-piece bed board; the two-piece bed board has two bed board frames movably pivoted to each other, and a supporting device installed under one of the two bed board frames and provided for supporting and tilting one of the two bed board frames to a selected angle in order to lift the patient's upper body.

5. The medical automatic turnover bed according to claim 4, wherein the supporting device is a manual adjusting supporting device or an electrical adjusting supporting device.

6. The medical automatic turnover bed according to claim 4, wherein the bed board has a plurality of boards installed thereon and arranged side by side with each other, and a selected portion of the plurality of boards can be separated and removed to form a hollow status.

7. The medical automatic turnover bed according to claim 1, wherein the fixed bed frame has a first horizontal frame and two first vertical frames disposed at front and rear ends of the first horizontal frame respectively; the turnover bed frame has a second horizontal frame spaced from the top of the first horizontal frame, two second vertical frames disposed at front and rear ends of the second horizontal frame respectively and two shafts axially coupled to the respective first vertical frames and the respective second vertical frame, such that the turnover bed frame can be turned over sideway with the shaft as a fulcrum.

8. The medical automatic turnover bed according to claim 7, wherein the shaft has an end fixed to the second vertical frame and the other end installed to the first vertical frame through a separable structure, such that the turnover bed frame can be separated from the fixed bed frame.

9. The medical automatic turnover bed according to claim 7, wherein the first horizontal frame is combined with a plurality of bed feet, and a roller is installed to the lower end of each bed foot.

10. The medical automatic turnover bed according to claim 1, wherein the electric driving device comprises a motor and a reduction transmission mechanism which are fixed to the fixed bed frame, and the motor drives the reduction transmission mechanism, and the reduction transmission mechanism drives the turnover bed frame.

11. The medical automatic turnover bed according to claim 7, wherein the electric driving device comprises a motor and a reduction transmission mechanism which are fixed to the fixed bed frame, and the motor drives the reduction transmission mechanism, and the reduction transmission mechanism drives the turnover bed frame.
